(19) United States
(12) Patent Application Publication
(10) Pub. No.: US 2008/0121542 A1
(43) Pub. Date: May 29, 2008

(54) Toolbox frame

(76) Inventor: Ming-Chi Chang, Taichung City (TW)

Correspondence Address: Ming-Chi Chang;235 Chung - Ho, Box 8-24, Taipei, omitted

(21) Appl. No.: 11/603,681

(22) Filed: Nov. 24, 2006

(51) Int. Cl. B25H 3/02

(52) U.S. Cl. 206/349; 211/49.1

(57) ABSTRACT

A toolbox frame comprises twelve connecting tubes; eight tri-tube assemblies; each tri-tube assembly including three sub-tubes which are approximately perpendicular to each other and communicated to each other; each sub-tube being connected to a respective connecting tube; the tri-tube assemblies and the connecting tubes being connected as a cubic structure. Each connecting tube is made of hollow aluminum. A handle is at an upper side; two ends of the handle have respective engaging portions so as to be engaged with middle sections of two parallel connecting tubes. Two receiving portions are at two opposite sides of the body of the toolbox frame; each receiving portion is screwed to inner sides of the two longitudinal connecting tubes. Each receiving portion is installed with a plurality of parallel tracks which are arranged along transversal directions. A backside of each track has a stop.

### FIELD OF THE INVENTION

The present invention relates to toolboxes, and particularly to a toolbox frame which is formed as a cubic structure including eight tri-tube assemblies and twelve connecting tubes. The structure is simple and can be assembled easily.

### BACKGROUND OF THE INVENTION

The prior art toolbox has a transparent upper cover so that the user can find a desired toolbox easily. However in use, the users must transfer a plurality of toolboxes a time. Thus it is very inconvenient and therefore, toolbox frames are designed. In one improvement, the toolbox frame has an upper plate, a lower plate and a backside plate, and thus three sides of the toolbox frame are opened for receiving. Two lateral sides are pivotally installed with lateral plates. Each lateral plate is installed with a plurality of tracks.

However above mentioned structure has the defects that it is heavy and has a great volume and thus is inconvenient in storage and transfer. Furthermore, the lateral plates make the user can not view the toolboxes therein. Furthermore, the structure is complicated and thus the assembly work is tedious and time consumed.

### SUMMARY OF THE INVENTION

Accordingly, the primary object of the present invention is to provide a toolbox frame which is formed as a cubic structure including eight tri-tube assemblies and twelve connecting tubes. The structure is simple and can be assembled easily.

To achieve above objects, the present invention provides a toolbox frame comprising: twelve connecting tubes; eight tri-tube assemblies; each tri-tube assembly including three sub-tubes which are approximately perpendicular to each other and communicated to each other; each sub-tube being connected to a respective connecting tube; the tri-tube assemblies and the connecting tubes being connected as a cubic structure. Each connecting tube is made of hollow aluminum. A handle is at an upper side; two ends of the handle have respective engaging portions so as to be engaged with middle sections of two parallel connecting tubes. Two receiving portions are at two opposite sides of the body of the toolbox frame; each receiving portion is screwed to inner sides of the two longitudinal connecting tubes. Each receiving portion is installed with a plurality of parallel tracks which are arranged along transversal directions. A backside of each track has a stop which is a protrusion vertical to the track for confining the movement of the toolbox not to move out of the backside of the track.

The various objects and advantages of the present invention will be more readily understood from the following detailed description when read in conjunction with the appended drawing.

### BRIEF DESCRIPTION OF THE DRAWINGS

FIG. 1 is an exploded perspective view of the toolbox frame of the present invention.

FIG. 2 is a schematic view showing the application of the present invention.

FIG. 3 is a perspective view of the toolbox frame of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

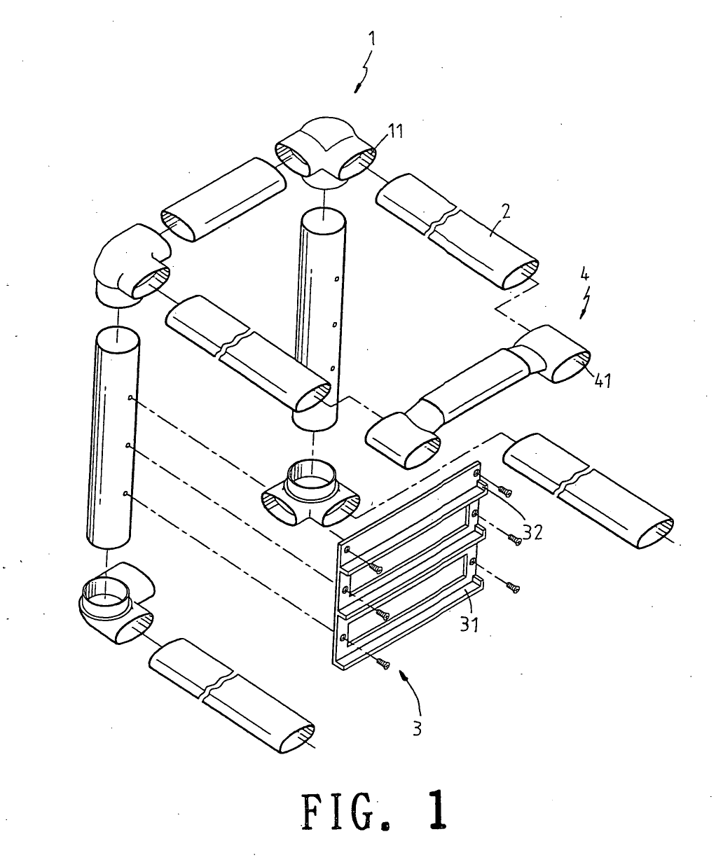

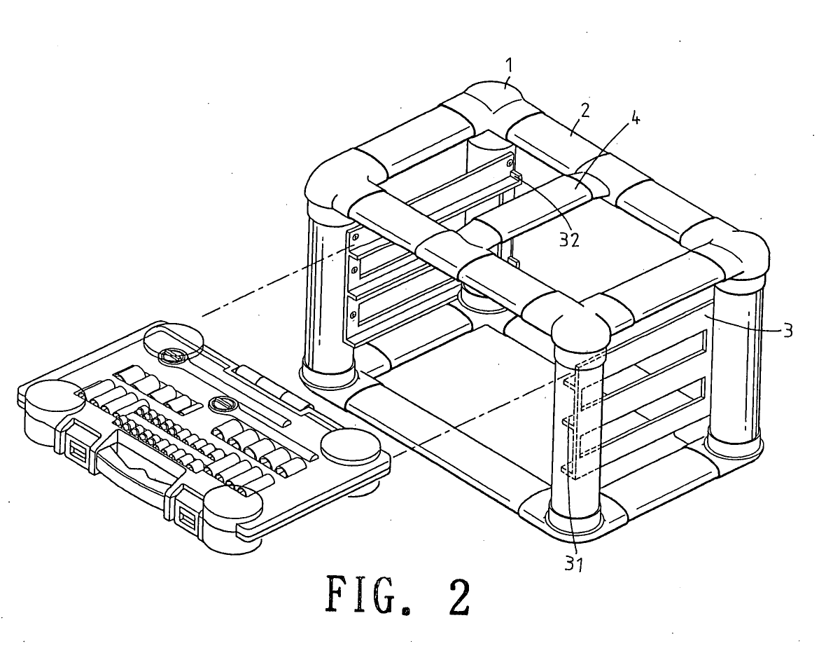

Referring to FIG. 1 and 2, the body of the toolbox frame of the present invention is illustrated. The present invention has the following elements.

Twelve connecting tubes 2 are aluminum hollow tubes.

Each of eight tri-tube assemblies 1 includes three sub-tubes 11 which are perpendicular to each other and communicated to each other. Each sub-tube 11 is connected to a respective connecting tube 2. The tri-tube assemblies 1 and the connecting tubes 2 are connected as a cubic structure.

A handle 4 is at an upper side. Two ends of the handle 4 have respective engaging portions 41 so as to be engaged with middle sections of two parallel connecting tubes 2.

Two receiving portions 3 are at two opposite sides of the body of the toolbox frame. Each receiving portion 3 is screwed to inner sides of the two longitudinal connecting tubes 2. The distance between the two receiving portions 3 is sufficient to receive a toolbox.

Each receiving portion 3 is formed with a plurality of parallel tracks 31 which are arranged along transversal directions. The tracks of a receiving portion 3 are parallel to the tracks 31 of another receiving portion 3 at opposite side of the toolbox frame. A backside of each track 31 has a stop 32 which is a protrusion vertical to the track 31 for confining the movement of the toolbox not to move out of the backside of the track 31.

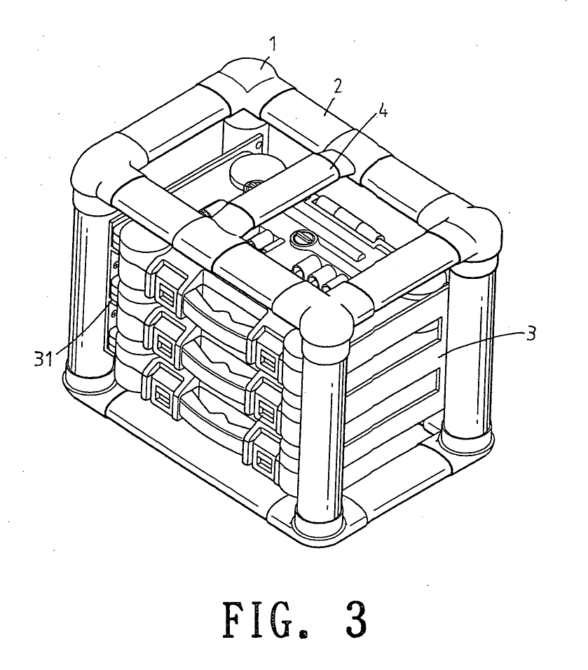

Referring to FIGS. 2 and 3, when a toolbox is placed into the toolbox frame of the present invention, it is placed upon two tracks 31 and are confined by the stops 32. A plurality of toolboxes can be placed into the toolbox frame of the present invention which is limited by the number of the tracks 31 of the present invention. The handle 4 makes the user cap hold the toolbox by hands easily.

The toolbox frame of the present invention is formed by 8 tri-tube assemblies 1, 12 connecting tubes 2, two receiving portions 3 and a handle 4. The structure of the present invention is simple and can be assembled easily and conveniently.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A toolbox frame comprising:
twelve connecting tubes;
eight tri-tube assemblies; each tri-tube assembly including three sub-tubes which are approximately perpendicular to each other and communicated to each other; each sub-tube being connected to a respective connecting tube; the tri-tube assemblies and the connecting tubes being connected as a cubic structure.

2. The toolbox frame as claimed in claim 1, wherein each connecting tube is made of hollow aluminum.

3. The toolbox frame as claimed in claim 1, wherein a handle is at an upper side; two ends of the handle have respective engaging portions so as to be engaged with middle sections of two parallel connecting tubes.

4. The toolbox frame as claimed in claim 1, wherein two receiving portions are at two opposite sides of the body of the toolbox frame; each receiving portion is screwed to inner sides of the two longitudinal connecting tubes.

5. The toolbox frame as claimed in claim 1, wherein each receiving portion is installed with a plurality of parallel tracks which are arranged along transversal directions.

6. The toolbox frame as claimed in claim 1, wherein a backside of each track has a stop which is a protrusion vertical to the track for confining the movement of the toolbox not to move out of the backside of the track.
